(19) United States
(12) Patent Application Publication
(10) Pub. No.: US 2024/0163952 A1
(43) Pub. Date: May 16, 2024

(54) BEAM FAILURE RECOVERY IN MULTIPLE TRANSMISSION RECEPTION POINT SCENARIO

(71) Applicant: Nokia Technologies Oy, Espoo (FI)

(72) Inventors: Timo KOSKELA, Oulu (FI); Samuli Heikki TURTINEN, Oulu (FI); Youngsoo YUK, Seoul (KR)

(21) Appl. No.: 18/550,388

(22) PCT Filed: Mar. 31, 2021
(86) PCT No.: PCT/EP2021/058506

§ 371 Date: Sep. 13, 2023

(51) Int. Cl. H04W 76/19; H04W 24/08; H04W 80/02

(52) U.S. Cl. CPC H04W 76/19; H04W 24/08; H04W 80/02

(57) ABSTRACT

The present disclosure relates generally to the field of wireless communications, and particularly to a technique for performing the beam failure recovery (BFR) of transmission reception points (TRPs) in a multiple-TRP (mTRP) scenario. More specifically, the technique involves defining rules according to which a UE may determine that the TRPs have failed concurrently or the TRPs are considered to fail individually in the mTRP scenario. Such rules are defined based on current counter values of beam failure instance (BFI) counters used by the UE for each of the TRPs. In some embodiments, the rules may be additionally defined based on current timer statuses of timers supervising the BFI counters. By using the rules thus defined, it is possible for the UE to clearly determine when it is required to use the BFR mechanism individually for at least one of the TRPs or concurrently for all the TRPs in one or more cells.

### TECHNICAL FIELD

The present disclosure relates generally to the field of wireless communications, and particularly to a technique that allows a user equipment (UE) to perform beam failure recovery (BFR) individually or concurrently for multiple transmission reception points (TRPs) in one or more cells of a wireless communication network.

### BACKGROUND

In wireless communications, BFR may be initiated by a UE upon detecting one or more beam failure instances (BFIs), which may occur, for example, when a serving beam used by the UE to communicate with a TRP becomes unable to provide a desired communication quality (e.g., the quality falling below a threshold determined based on a downlink (DL) reference signal (RS) configured for control and/or data transmission by the TRP). There are different BFR options currently discussed in the 3rd Generation Partnership Project (3GPP).

More specifically, one discussion point relates to a BFR mechanism which should be used when multiple/all TPRs in a serving cell are in failure condition, i.e. their corresponding serving beams do not provide the desired communication quality. One of undefined aspects in this respect is how the UE may determine that all TRPs are in failure condition, i.e. when the UE should or is required to trigger the BFR mechanism individually or concurrently for the TRPs in the serving cell.

The most straightforward way to resolve this issue could consist in determining the concurrent failure (i.e. when all TRPs are considered to be in failure condition) when BFI-counters used in the TRPs reach a predefined maximum value at the same time. However, this way may not allow the UE to clearly determine said “same time”, which may reduce the efficiency of using the BFR mechanism (e.g., the UE may mistakenly decide to use the BFR mechanism concurrently for all TRPs in the serving cell when it is enough to use the BFR mechanism only for one of the TRPs).

### SUMMARY

This summary is provided to introduce a selection of concepts in a simplified form that are further described below in the detailed description. This summary is not intended to identify key features or essential features of the present disclosure, nor is it intended to be used to limit the scope of the present disclosure.

It is an object of the present disclosure to provide a technical solution that allows a UE to clearly determine when a BFR mechanism should be initiated individually or concurrently for multiple TRPs in one or more cells of a wireless communication network.

The object above is achieved by the features of the independent claims in the appended claims. Further embodiments and examples are apparent from the dependent claims, the detailed description and the accompanying drawings. The embodiments that do not fall under the scope of the claims are to be interpreted as examples useful for understanding the present disclosure.

According to a first aspect, a UE for wireless communications is provided. The UE comprises a transceiving unit, a storage unit, and at least one processor. The storage unit is configured to store processor-executable instructions. Being executed by the at least one processor, the processor-executable instructions cause the at least one processor to operate as follows. At first, the at least one processor causes the transceiving unit to perform wireless communications with a first TRP by using at least one first serving beam and with a second TRP by using at least one second serving beam. Then, the at least one processor assigns a first counter and a first timer to the first TRP. The first counter has a counter value incremented by 1 whenever a BFI for the first TRP occurs. The BFI for the first TRP implies that the at least one first serving beam becomes unable to provide a predefined communication quality. The first timer is triggered in response to the BFI for the first TRP, and the first counter is reset when the first timer expires. Next, the at least one processor assigns a second counter and a second timer to the second TRP. Similar to the first counter, the second counter has a counter value incremented by 1 whenever a BFI for the second TRP occurs. The BFI for the second TRP implies that the at least one second serving beam becomes unable to provide the predefined communication quality. Similar to the first timer, the second timer is triggered in response to the BFI for the second TRP, and the second counter is reset when the second timer expires. After that, the at least one processor decides whether to initiate a BFR mechanism for at least one of the first TRP and the second TRP based on: (i) the current counter value of each of the first counter and the second counter; or (ii) the current counter value of at least one of the first counter and the second counter and at least one of the first timer and the second timer. With such configuration, the UE may clearly determine when it is required to use the BFR mechanism individually for at least one of the TRPs or concurrently for all TRPs in one or more cells.

In one example embodiment of the first aspect, each of the first counter and the second counter has a maximum counter value. In this example embodiment, the at least one processor is configured to initiate the BFR mechanism for both the first TRP and the second TRP if (i) the current counter value of the first counter is equal to the maximum counter value of the first counter, and (ii) the current counter value of the second counter is a predefined counter value. The predefined counter value is less than or equal to the maximum counter value of the second counter. By so doing, the UE may clearly determine when it is required to use the BFR mechanism concurrently for all TRPs in the cell(s).

In one example embodiment of the first aspect, each of the first counter and the second counter has a maximum counter value. In this example embodiment, the at least one processor is configured to initiate the BFR mechanism for the first TRP if (i) the current counter value of the first counter is equal to the maximum counter value of the first counter, and (ii) the current counter value of the second counter is equal to 0. By so doing, the UE may clearly determine when it is required to use the BFR mechanism individually for one of the TRPs in the cell(s).

In one example embodiment of the first aspect, each of the first counter and the second counter has a maximum counter value. In this example embodiment, the at least one processor is configured to initiate the BFR mechanism for the first TRP if the current counter value of the first counter reaches the maximum counter value of the first counter, while the current counter value of the second counter is less than a predefined counter value. The predefined counter value is less than or equal to the maximum counter value of the second counter. By so doing, the UE may clearly determine when it is required to use the BFR mechanism individually for one of the TRPs in the cell(s).

In one example embodiment of the first aspect, each of the first counter and the second counter has a maximum counter value. In this example embodiment, the at least one processor is configured to initiate the BFR mechanism for both the first TRP and the second TRP if a sum of the current counter values of the first counter and the second counter is equal to: (i) the lowest or highest of the maximum counter values of the first counter and the second counter; or (ii) a sum of the maximum counter values of the first counter and the second counter; or (iii) a predefined threshold value. By so doing, the UE may clearly determine when it is required to use the BFR mechanism concurrently for all TRPs in the cell(s).

In one example embodiment of the first aspect, each of the first counter and the second counter has a maximum counter value. In this example embodiment, the at least one processor is configured to initiate the BFR mechanism for both the first TRP and the second TRP if (i) the current counter value of the first counter reaches the maximum counter value of the first counter at a time instant, and (ii) the current counter value of the second counter reaches the maximum counter value of the second counter within a predefined time interval from the time instant. By so doing, the UE may clearly determine when it is required to use the BFR mechanism concurrently for all TRPs in the cell(s).

In one example embodiment of the first aspect, each of the first counter and the second counter has a maximum counter value. In this example embodiment, the at least one processor is configured to initiate the BFR mechanism for both the first TRP and the second TRP if (i) the current counter value of the first counter is equal to the maximum counter value of the first counter, and (ii) a new BFI for the second TRP occurs before the second timer expires, and the new BFI makes the current counter value of the second counter equal to the maximum counter value of the second counter. By so doing, the UE may clearly determine when it is required to use the BFR mechanism concurrently for all TRPs in the cell(s).

In one example embodiment of the first aspect, each of the first counter and the second counter has a maximum counter value. In this example embodiment, the at least one processor is configured to initiate the BFR mechanism for both the first TRP and the second TRP if (i) the current counter value of the first counter is equal to the maximum counter value of the first counter, and (ii) a new BFI for the second TRP occurs before the second timer expires, and the new BFI makes the current counter value of the second counter equal to a predefined counter value. The predefined counter value is less than or equal to the maximum counter value of the second counter. By so doing, the UE may clearly determine when it is required to use the BFR mechanism concurrently for all TRPs in the cell(s).

In one example embodiment of the first aspect, each of the first counter and the second counter has a maximum counter value. In this example embodiment, the at least one processor is configured to initiate the BFR mechanism for both the first TRP and the second TRP if (i) the current counter value of the first counter is equal to the maximum counter value of the first counter, and (ii) a new BFI for the second TRP occurs before the second timer expires. By so doing, the UE may clearly determine when it is required to use the BFR mechanism concurrently for all TRPs in the cell(s).

In one example embodiment of the first aspect, each of the first counter and the second counter has a maximum counter value. In this example embodiment, the at least one processor is configured to initiate the BFR mechanism for both the first TRP and the second TRP if (i) the current counter values of the first counter and the second counter are equal to the maximum counter values of the first counter and the second counter, respectively, and (ii) a new BFI for the first TRP occurs before the second timer expires. By so doing, the UE may clearly determine when it is required to use the BFR mechanism concurrently for all TRPs in the cell(s).

In one example embodiment of the first aspect, each of the first counter and the second counter has a maximum counter value. In this example embodiment, the at least one processor is configured to initiate the BFR mechanism for the first TRP if (i) the current counter value of the first counter is equal to the maximum counter value of the first counter, and (ii) the second timer has expired. By so doing, the UE may clearly determine when it is required to use the BFR mechanism individually for one of the TRPs in the cell(s).

In one example embodiment of the first aspect, the first TRP and the second TRP are arranged in a single cell or in different two cells. This may make the UE according to the first aspect more flexible in use because it may operate both in intra-cell and inter-cell scenarios.

According to a second aspect, a wireless communications method is provided. The method starts with the step of causing a UE to communicate with a first TRP by using at least one first serving beam and with a second TRP by using at least one second serving beam. Then, the method proceeds to the step of assigning a first counter and a first timer to the first TRP. The first counter has a counter value incremented by 1 whenever a new BFI for the first TRP occurs. The BFI for the first TRP implies that the at least one first serving beam becomes unable to provide a predefined communication quality. The first timer is triggered in response to the BFI for the first TRP, and the first counter is reset when the first timer expires. Next, the method goes on to the step of assigning a second counter and a second timer to the second TRP. Similar to the first counter, the second counter has a counter value incremented by 1 whenever a new BFI for the second TRP occurs. The BFI for the second TRP implies that the at least one second serving beam becomes unable to provide the predefined communication quality. Similar to the first timer, the second timer is triggered in response to the BFI for the second TRP, and the second counter is reset when the second timer expires. After that, the method proceeds to the step of deciding whether to initiate a BFR mechanism for at least one of the first TRP and the second TRP based on: (i) the current counter value of each of the first counter and the second counter; or (ii) the current counter value of at least one of the first counter and the second counter and at least one of the first timer and the second timer. By so doing, it is possible for the UE to clearly determine when it is required to use the BFR mechanism individually for at least one of the TRPs or concurrently for all TRPs in one or more cells.

In one example embodiment of the second aspect, each of the first counter and the second counter has a maximum counter value. In this example embodiment, the BFR mechanism is initiated for both the first TRP and the second TRP if (i) the current counter value of the first counter is equal to the maximum counter value of the first counter, and (ii) the current counter value of the second counter is equal to a predefined counter value. The predefined counter value is less than or equal to the maximum counter value of the second counter. By so doing, the UE may clearly determine when it is required to use the BFR mechanism concurrently for all TRPs in the cell(s).

In one example embodiment of the second aspect, each of the first counter and the second counter has a maximum counter value. In this example embodiment, the BFR mechanism is initiated for the first TRP if (i) the current counter value of the first counter is equal to the maximum counter value of the first counter, and (ii) the current counter value of the second counter is equal to 0. By so doing, the UE may clearly determine when it is required to use the BFR mechanism individually for one of the TRPs in the cell(s).

In one example embodiment of the second aspect, each of the first counter and the second counter has a maximum counter value. In this example embodiment, the BFR mechanism is initiated for the first TRP if the current counter value of the first counter reaches the maximum counter value of the first counter, while the current counter value of the second counter is less than the maximum counter value of the second counter. By so doing, the UE may clearly determine when it is required to use the BFR mechanism individually for one of the TRPs in the cell(s).

In one example embodiment of the second aspect, each of the first counter and the second counter has a maximum counter value. In this example embodiment, the BFR mechanism is initiated for both the first TRP and the second TRP if a sum of the current counter values of the first counter and the second counter is equal to: (i) the lowest or highest of the maximum counter values of the first counter and the second counter; or (ii) a sum of the maximum counter values of the first counter and the second counter; or (iii) a predefined threshold value. By so doing, the UE may clearly determine when it is required to use the BFR mechanism concurrently for all TRPs in the cell(s).

In one example embodiment of the second aspect, each of the first counter and the second counter has a maximum counter value. In this example embodiment, the BFR mechanism is initiated for both the first TRP and the second TRP if (i) the current counter value of the first counter reaches the maximum counter value of the first counter at a time instant, and (ii) the current counter value of the second counter reaches the maximum counter value of the second counter within a predefined time interval from the time instant. By so doing, the UE may clearly determine when it is required to use the BFR mechanism concurrently for all TRPs in the cell(s).

In one example embodiment of the second aspect, each of the first counter and the second counter has a maximum counter value. In this example embodiment, the BFR mechanism is initiated for both the first TRP and the second TRP if (i) the current counter value of the first counter is equal to the maximum counter value of the first counter, and (ii) a new BFI for the second TRP occurs before the second timer expires, and the new BFI makes the current counter value of the second counter equal to the maximum counter value of the second counter. By so doing, the UE may clearly determine when it is required to use the BFR mechanism concurrently for all TRPs in the cell(s).

In one example embodiment of the second aspect, each of the first counter and the second counter has a maximum counter value. In this example embodiment, the BFR mechanism is initiated for both the first TRP and the second TRP if (i) the current counter value of the first counter is equal to the maximum counter value of the first counter, and (ii) a new BFI for the second TRP occurs before the second timer expires, and the BFI makes the current counter value of the second counter equal to a predefined counter value. The predefined counter value is less than or equal to the maximum counter value of the second counter. By so doing, the UE may clearly determine when it is required to use the BFR mechanism concurrently for all TRPs in the cell(s).

In one example embodiment of the second aspect, each of the first counter and the second counter has a maximum counter value. In this example embodiment, the BFR mechanism is initiated for both the first TRP and the second TRP if (i) the current counter value of the first counter is equal to the maximum counter value of the first counter, and (ii) a new BFI for the second TPR occurs before the second timer expires. By so doing, the UE may clearly determine when it is required to use the BFR mechanism concurrently for all TRPs in the cell(s).

In one example embodiment of the second aspect, each of the first counter and the second counter has a maximum counter value. In this example embodiment, the BFR mechanism is initiated for both the first TRP and the second TRP if (i) the current counter values of the first counter and the second counter are equal to the maximum counter values of the first counter and the second counter, respectively, and (ii) a new BFI for the first TRP occurs before the second timer expires. By so doing, the UE may clearly determine when it is required to use the BFR mechanism concurrently for all TRPs in the cell(s).

In one example embodiment of the second aspect, each of the first counter and the second counter has a maximum counter value. In this example embodiment, the BFR mechanism is initiated for the first TRP if (i) the current counter value of the first counter is equal to the maximum counter value of the first counter, and (ii) the second timer has expired. By so doing, the UE may clearly determine when it is required to use the BFR mechanism individually for one of the TRPs in the cell(s).

In one example embodiment of the second aspect, the first TRP and the second TRP are arranged in a single cell or in different cells. This may make the method according to the second aspect more flexible in use because it may be applied both in intra-cell and inter-cell scenarios.

According to a third aspect, a computer program product is provided, which comprises a computer-readable medium having a computer code stored thereon. The computer code, when executed by at least one processor, causes the at least one processor to perform the method according to the second aspect of the present disclosure. This may simplify the implementation of the method according to the second aspect of the present disclosure on any wireless communication device, such as the UE according to the first aspect of the present disclosure.

According to a fourth aspect, a UE for wireless communications is provided. The UE comprises a transceiving means, a storing means, and a processing means. The storing means is configured to store processor-executable instructions. Being executed by the processing means, the processor-executable instructions cause the processing means to operate as follows. At first, the processing means causes the transceiving means to perform wireless communications with a first TRP by using at least one first serving beam and with a second TRP by using at least one second serving beam. Then, the processing means assigns a first counter and a first timer to the first TRP. The first counter has a counter value incremented by 1 whenever a BFI for the first TRP occurs. The BFI for the first TRP implies that the at least one first serving beam becomes unable to provide a predefined communication quality. The first timer is triggered in response to the BFI for the first TRP, and the first counter is reset when the first timer expires. Next, the processing means assigns a second counter and a second timer to the second TRP. Similar to the first counter, the second counter has a counter value incremented by 1 whenever a BFI for the second TRP occurs. The BFI for the second TRP implies that the at least one second serving beam becomes unable to provide the predefined communication quality. Similar to the first timer, the second timer is triggered in response to the BFI for the second TRP, and the second counter is reset when the second timer expires. After that, the processing means decides whether to initiate a BFR mechanism for at least one of the first TRP and the second TRP based on: (i) the current counter value of each of the first counter and the second counter; or (ii) the current counter value of at least one of the first counter and the second counter and at least one of the first timer and the second timer. With such configuration, the UE may clearly determine when it is required to use the BFR mechanism individually for at least one of the TRPs or concurrently for all TRPs in cell(s).

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a block diagram of a wireless communication system in which a beam failure recovery (BFR) mechanism is initiated in a single transmission reception point (TRP) scenario;

FIG. 2 shows a block diagram of a wireless communication system in which the BFR mechanism is initiated in a multiple TRP (mTRP) scenario;

FIG. 3 shows one example of a medium access control (MAC) control element (CE) (MAC CE) which may be used in the BFR mechanism for a secondary cell (SCell);

FIG. 4 schematically illustrates an mTRP beam failure detection (BFD) approach proposed in 3GPP Release 17;

FIG. 5 shows a block diagram of a UE for wireless communications in accordance with one example embodiment;

FIG. 6 shows a flowchart of a wireless communication method in accordance with one example embodiment;

FIG. 7 schematically illustrates one of rules that prescribe the UE shown in FIG. 1 to initiate the BFR mechanism for one of TRPs in the mTRP scenario.

### DETAILED DESCRIPTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatus and method disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment described herein as “example embodiment” should not be construed as preferable or having an advantage over other embodiments.

Although the numerative terminology, such as “first”, “second”, etc., may be used herein to describe various elements, it should be understood that these elements should not be limited by this numerative terminology. This numerative terminology is used herein only to distinguish one element from another element. Thus, a first TRP, counter or timer discussed below could be called a second TRP, counter or timer, respectively, without departing from the teachings of the present disclosure.

According to the example embodiments disclosed herein, a user equipment or UE for short may refer to a mobile device, a mobile station, a terminal, a subscriber unit, a mobile phone, a cellular phone, a smart phone, a cordless phone, a personal digital assistant (PDA), a wireless communication device, a desktop computer, a laptop computer, a tablet computer, a single-board computer (SBC) (e.g., a Raspberry Pi device), a gaming device, a netbook, a smartbook, an ultrabook, a medical device or medical equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IoT) device, an Industrial IoT (IIoT) device, a machine-type communication (MTC) device, a group of Massive IoT (MIoT) or Massive MTC (mMTC) devices/sensors, or any other suitable device configured to support wireless communications. In some embodiments, the UE may refer to at least two collocated and inter-connected UEs thus defined.

According to the example embodiments disclosed herein, a transmission reception point or TRP for short may refer to a fixed point of communication for the UE in a particular wireless communication network. The TRP may be implemented as a Radio Access Network (RAN) node referred to as a base transceiver station (BTS) in terms of the 2G communication technology, a NodeB in terms of the 3G communication technology, an evolved NodeB (eNodeB) in terms of the 4G communication technology, and a gNB in terms of the 5G New Radio (NR) communication technology. The RAN node may serve different cells, such as a macrocell, a microcell, a picocell, a femtocell, and/or other types of cells. The macrocell may cover a relatively large geographic area (for example, at least several kilometers in radius). The microcell may cover a geographic area less than two kilometers in radius, for example. The picocell may cover a relatively small geographic area, such, for example, as offices, shopping malls, train stations, stock exchanges, etc. The femtocell may cover an even smaller geographic area (for example, a home). Correspondingly, the RAN node serving the macrocell may be referred to as a macro node, the RAN node serving the microcell may be referred to as a micro node, and so on.

Each TRP may transmit a plurality of beams to the UE. A serving beam may be determined, from the plurality of beams, for providing wireless communications (i.e. a wireless communication channel) between the TRP and the UE. One or more candidate beams may also be determined, from the plurality of beams, for providing the wireless communications if a beam failure instance (BFI) occurs, for example, when the serving beam becomes unable to provide a desired communication quality. One or more candidate beams may be determined by the UE and/or by the TRP. By determining and configuring a candidate beam, the UE and the TRP may continue the wireless communications even if the serving beam experiences the BFI.

The UE may measure the communication quality of the serving beam (i.e. the beam used in a Physical Downlink Control Channel (PDCCH) or Physical Downlink Shared Channel (PDSCH)) using one or more reference signals (RSs). One or more synchronization signal (SS) blocks (SSBs), one or more channel state information RS (CSI-RS) resources, and/or one or more demodulation RSs (DM-RSs) of a physical broadcast channel (PBCH) may be used as a RS for measuring the communication quality of the serving beam. The communication quality of the serving beam may be based on at least one of an RS received power (RSRP) value, RS received quality (RSRQ) value, and CSI value measured on RS resources. The TRP may provide such RS resources to the UE, for example, via dedicated radio resource control (RRC) signaling.

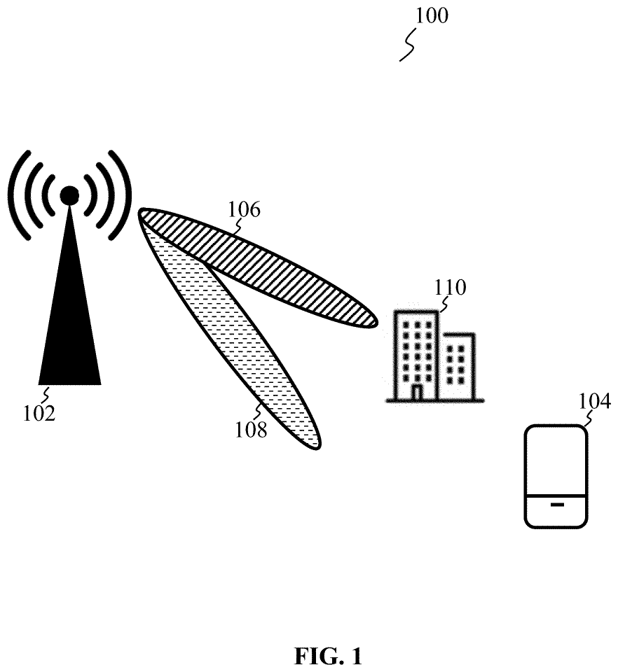

FIG. 1 shows a block diagram of a wireless communication system 100 in which a beam failure recovery (BFR) mechanism is initiated in a single-TRP scenario. As shown in FIG. 1, the system 100 comprises a single TRP 102 and a UE 104 implemented as a smartphone. As an example, the TRP 102 transmits, to the UE 104, a first beam 106 and a second beam 108. A BFI may occur if the second beam 108 selected as a serving beam is blocked by a building 110 or any other obstacle (e.g., a moving vehicle, tree, landscape element, or any object) and, therefore, is no longer able to provide a desired communication quality. In response to the BFI, the UE 104 may trigger a mechanism to recover from beam failure, which is hereinafter referred to as the BFR mechanism.

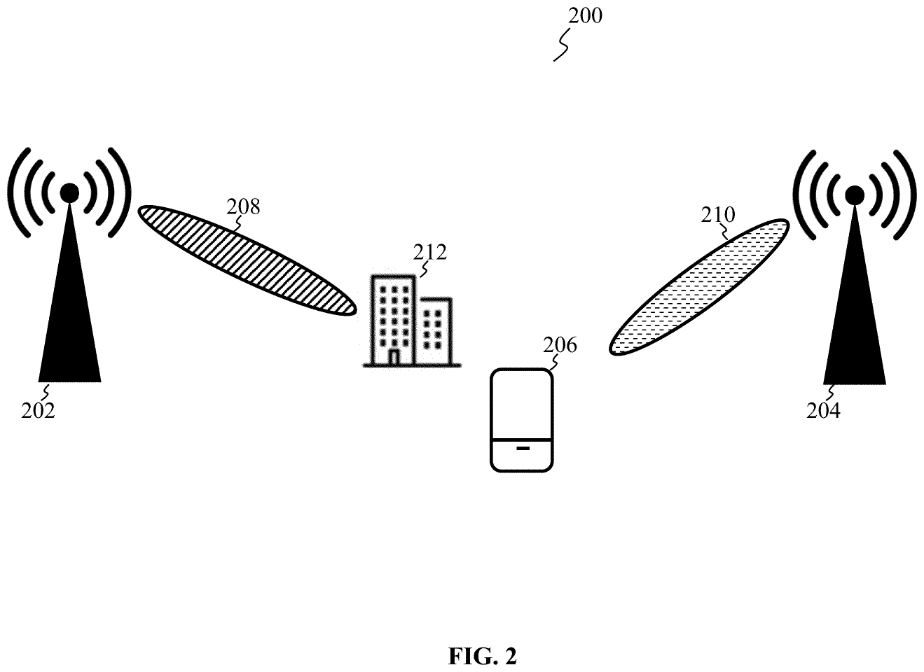

FIG. 2 shows a block diagram of a wireless communication system 200 in which the BFR mechanism is initiated in a multiple-TRP (mTRP) scenario. As shown in FIG. 2, the system 200 comprises a TRP 202, a TRP 204, and a UE 206 implemented as a smartphone. It should be noted that the mTRP scenario implies operation where the UE 206 is served using all TRP in a serving cell, i.e. both the TRP 202 and the TRP 204 in the example shown in FIG. 2. To provide such operation, the TRP 202 transmits a serving beam 208 to the UE 206, while the TRP 204 transmits a serving beam 210 to the UE 206. Similar to the system 100, a BFI may occur in the system 200 when, for example, the serving beam 208 is blocked by a building 212 or any other obstacle (e.g., a moving car, tree, landscape element, or any object). In this case, the UE 206 may trigger the BFR mechanism when such a BFI occurs.

The BFR mechanism for a primary cell (PCell) was specified in 3GPP Release 15 (and enhanced later in 3GPP Release 16). The BFR mechanism for one or more secondary cells (SCells) was specified in 3GPP Release 16. In the SCell BFR mechanism, a UE performs beam failure detection (BFD) for one or more configured SCells. The SCell BFD procedure is similar to the one defined in 3GPP Release 15 for the PCell: for each of the configured SCells, the UE determines a corresponding set of BFD resources (the so-called set q0 of BFD-RSs) in implicit or explicit manner. In the implicit configuration, the UE determines a BFD-RS based on the RS indicated by active transmission configuration indication (TCI) states for the PDCCH. In the explicit configuration, the UE performs the BFD procedure according to the RS configured by the TRP itself.

Given the open systems interconnection (OSI) model, the physical layer or layer L1 determines, based on a downlink RS (DL RS), such as SSB/CSI-RS, in the set q0 whether or not to indicate the BFI to a higher layer, i.e. a medium access control (MAC) layer (which is a sublayer of layer L2). When all the RSs in the set q0 are in failure condition, i.e. a hypothetical PDCCH block error rate (BLER) estimated on the RS is above a threshold value (e.g., above 10%), the UE indicates the BFI to the higher layer.

The MAC layer uses a BFI-counter to count the BFI indications for each respective cell and when it counts a predefined number of BFI instances indicated by the lower layer for the corresponding cell (PCell/SCell), it initiates/triggers the BFR mechanism. The BFI-counter is supervised by a BFD timer. Each time the UE receives a new BFI indication, the BFD timer is triggered (started or restarted), and the BFI counter is incremented. If the BFD timer expires, the BFI-counter is reset. The BFI counter and BFD timer may be configured per TRP, per BFD-RS set or per serving beam or serving beam set. The serving beam may refer to a PDCCH or PDSCH beam. Duration values of the BFD timer may correspond to the Qout,LR reporting period of Beam Failure Detection (BFD) Reference Signals (RSs) (e.g., as per ETSI TS 38.331 V16.3.1: Value pbfd1 corresponds to 1 Qout,LR reporting period of BFD-RS, value pbfd2 corresponds to 2 Qout,LR reporting periods of BFD-RS, and so on). The physical layer informs the higher layers (the BFI indication) when a radio link quality is worse than the threshold Qout,LR with a periodicity determined by the maximum between the shortest periodicity among the SS/PBCH blocks on the PCell or a primary SCell (PSCell) and/or the periodic CSI-RS configurations in the set that the UE uses to assess the radio link quality and 2 msec.

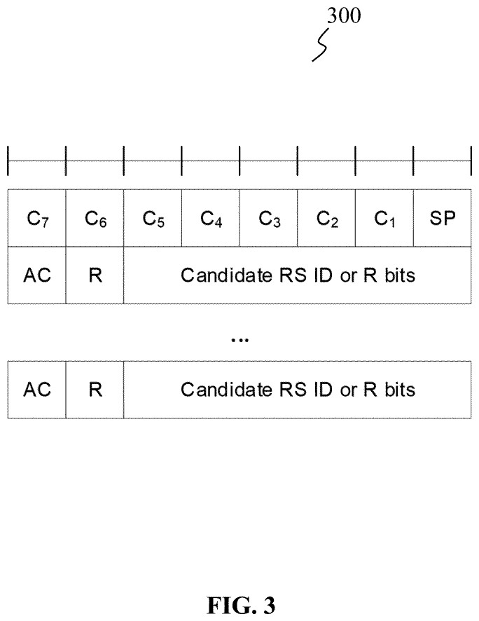

FIG. 3 shows one example of a MAC control element (CE) (MAC CE) 300 which may be used in the SCell BFR mechanism. More specifically, when the BFI is detected on at least one SCell, the UE may indicate the beam failure and recover the failed SCell using the MAC CE 300. The MAC CE 300 communicates, to the TRP, a failed-SCell index (via bits C1-C7), an indication whether a candidate beam is available (via a bit AC) and a candidate beam index (via a bit field “Candidate RS ID”). The UE may indicate a candidate beam that is on a candidate beam list (i.e. a list of candidate beam indices that are either SSB and/or CSI-RS indices). The same MAC CE 300 that may indicate SCell failure/recovery information may also be used for the PCell BFR mechanism by setting a PCell bit (SP) to indicate the failure.

In 3GPP Release 17, it has been proposed to enhance the BFR mechanism to cover the mTRP scenario like the one shown in FIG. 2. The mTRP scenario typically refers to operation based on single downlink control information (S-DCI) or multi-DCI (mDCI). In the mDCI operation, a control resource set (CORESET) index value (e.g., a CORESET pool index value) is used to group CORESETs under separate groups, i.e. when CORESETs share the same group ID or CORESET pool index value, they are considered to be in the same group. In the S-DCI operation, different CORESETs are not grouped, i.e. the same CORESET pool index value is configured for all the CORESETs.

When configured with more than one CORESET pool index value (e.g., 2 CORESET sets are configured in the mDCI operation), the UE may be expected to monitor DCI transmissions simultaneously from the CORESETs associated with different pool index values. It is currently possible to configure up to 2 CORESET pool index values (k=0, 1). In case of the S-DCI (i.e. no pool index value that could be used for determining the sets q0), the TRP may configure the UE explicitly by using the BFD-RS for corresponding CORESET sets.

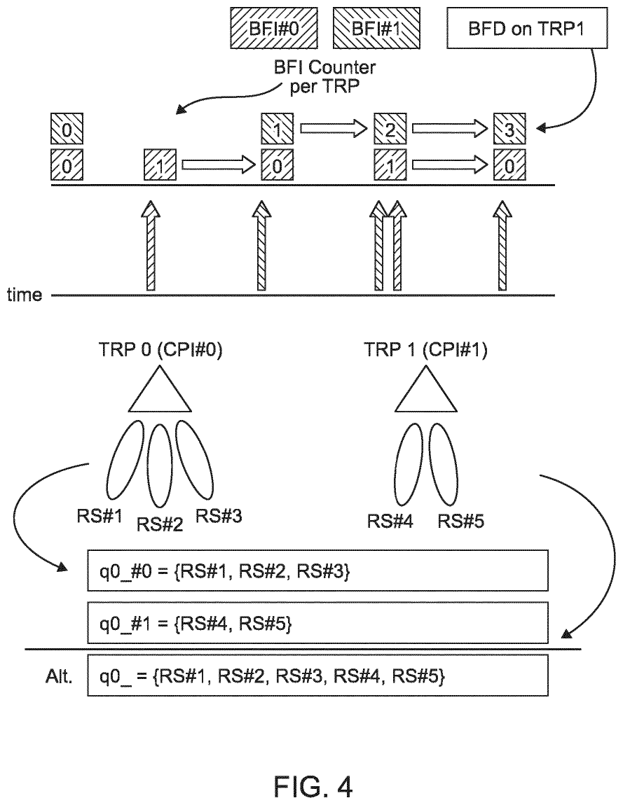

FIG. 4 schematically illustrates an mTRP BFD approach proposed in 3GPP Release 17. According to this approach, the UE may be configured to determine the failure of a of DL RS indicated by the PDCCH TCI states that are configured in different sets q0. As an example, the UE may be configured to determine when a specific set q0, e.g., either with k=0 or k=1, is in failure. This may be sometimes referred to as a TRP failure, e.g. the set q0, k=0 refers to the BFD-RS of one TRP and the set q0, k=1 refers to the BFD-RS of another TRP. In the MAC layer, the UE performs the BFD for the set q0, and the BFD relies on counting the BFI instances. More specifically, FIG. 4 refers to the mTRP scenario where two TRPs, i.e. TRP0 and TRP1, are used to serve the UE. It is assumed here that the TRP0 transmits three (e.g., PDCCH) beams to the UE, while the TRP1 transmits two (e.g., PDCCH) beams to the UE. The UE checks the communication quality of each of the beams from the TRP0 and the TRP1 by measuring corresponding RSs, i.e. RS #1, RS #2, RS #3 from the TRP0 and RS #4, RS #5 from the TRP1. The RSs from the TRP0 may be included in the set q0_#0, while the RSs from the TRP0 may be included in the set q0_#1. Alternatively, the RSs from both the TRP0 and the TRP1 may be provided as a single set q0_. To perform the BFD in multi TRP communication in the BFD-RS set/set q0 in a specific manner, it is required to consider the following: independent BFD procedures for each of the TRP0 and the TRP1 may be configured, wherein the DL RS indicated by the TCI State for the PDCCH may be included in the respective sets q0 (#0, #1) based on the CORESET association with a CORESET pool index (CPI) value k (k=0,1). The CORESETs under the same CPI value may be considered to be grouped for failure detection purposes; CORESETs are monitored for PDCCH transmission based on the activated TCI states (that indicate the DL RS) for the CORESETs. The DL RS indicated by the TCI state may be included in the respective set q0 based on the CPI value configured for the CORESET. Alternatively, the CORESETs or the BFD-RS may be divided into groups or sets, respectively, based on any higher layer parameter or implicit determination. Furthermore, the independent BFD procedures for each of the TRP0 and the TRP1 may be configured according to the sets q0_#0 and q0_#1 (for the TRP0 and the TRP1, respectively), or for the single set q0. The BFI-counter for each of the TRP0 and the TRP1. As an example, the counter values of the BFI-counters at different time instants are shown inside small boxes (with background of slash “/” for the TRP0 and backslash “\” for the TRP1) in FIG. 4 (see “0”, “1”, “2”, and “3” inside the small boxes). As can be seen, the beam failure occurs/is detected for the TRP1 (or, in other words, for all the BFD-RS beams from the TRP1) when the corresponding BFI-counter reaches 3 (in this example, the counter value 3 is the maximum counter value when the beam failure is considered to be detected), meaning that each of the two beams from the TRP1 is no longer able to provide the desired communication quality. Thus, this approach allows the UE to determine when all beams from a certain TRP are in failure condition, for which reason it is called the mTRP BFD approach. Once such a failed TRP is determined, the UE may initiate the BFR mechanism for the failed TRP.

However, the mTRP BFD approach shown in FIG. 4 does not allow the UE to understand when multiple/all TPRs (e.g., both the TRP0 and the TRP1) in a serving cell are in failure (i.e. all of their beams are unable to provide a desired communication quality). This is because the BFI-counters of the TRPs are used independently from each other, for which reason the UE cannot determine when the TRPs are concurrently in failure. Given this, the UE does not know when it is required to initiate the BFR mechanism for all the TRPs in the serving cell (i.e. the cell-level BFR mechanism). In other words, the mTRP BFD approach shown in FIG. 4 does not allow the UE to choose between the BFR mechanism for a certain TRP and the cell-level BFR mechanism.

Of course, the concurrent failure (i.e. when multiple/all TRPs are considered to be in failure condition) could be determined when the BFI-counters of the TRPs reach their maximum value at the same time. However, even defining the concurrent failure in this way leaves room for interpretation of how to clearly define said “same time”.

The exemplary embodiments disclosed herein provide a technical solution that allows mitigating or even eliminating the above-sounded drawbacks peculiar to the prior art. In particular, the technical solution disclosed herein involves defining rules according to which a UE may determine that TRPs have failed concurrently or the TRPs are considered to fail individually in the mTRP scenario. Such rules are defined based on counter values of BFI counters used by the UE for each of the TRPs. In some embodiments, the rules may be additionally defined based on statuses of timers supervising the BFI counters. By using the rules thus defined, it is possible for the UE to clearly determine when it is required to use the BFR mechanism individually for at least one of the TRPs or concurrently for all the TRPs in one or more cells.

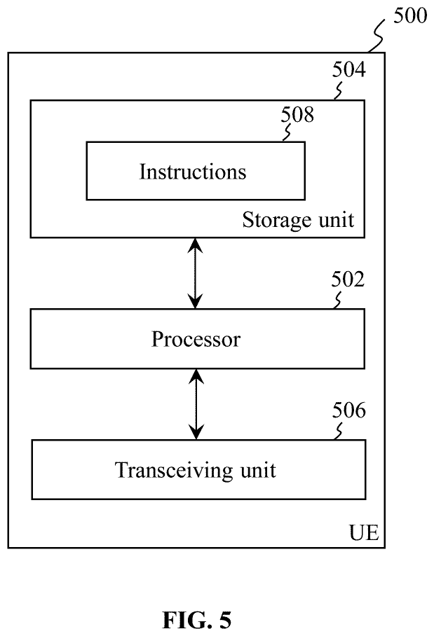

FIG. 5 shows a block diagram of a UE 500 for wireless communications in accordance with one example embodiment. As shown in FIG. 5, the UE 500 comprises the following constructive elements: a processor 502, a storage unit 504, and a transceiving unit 506. The storage unit 504 is coupled to the processor 502 and stores processor-executable instructions 508 which, when executed by the processor 502, cause the processor 502 to perform the aspects of the present disclosure, as will be explained later. It should be noted that the number, arrangement and interconnection of the constructive elements constituting the UE 500, which are shown in FIG. 5, are not intended to be any limitation of the present disclosure, but merely used to provide a general idea of how the constructive elements may be implemented within the UE 500. In one other example embodiment, the transceiving unit 506 may be implemented as two individual devices, with one for receiving operations and another for transmitting operation. Irrespective of its implementation, the transceiving unit 506 is implied to be capable of performing different operations required to perform the reception and transmission of different signals, such, for example, as signal modulation/demodulation.

The processor 502 may be implemented as a central processing unit (CPU), general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 502 may be implemented as any combination of one or more of the aforesaid. As an example, the processor may be a combination of two or more microprocessors.

The storage unit 504 may be implemented as a nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 508 stored in the storage unit 504 may be configured as a computer executable code which causes the processor 502 to perform the aspects of the present disclosure. The computer executable code for carrying out operations or steps for the aspects of the present disclosure may be written in any combination of one or more programming languages, such as Java, C++, or the like. In some examples, the computer executable code may be in the form of a high-level language or in a pre-compiled form, and be generated by an interpreter (also pre-stored in the storage unit 504) on the fly.

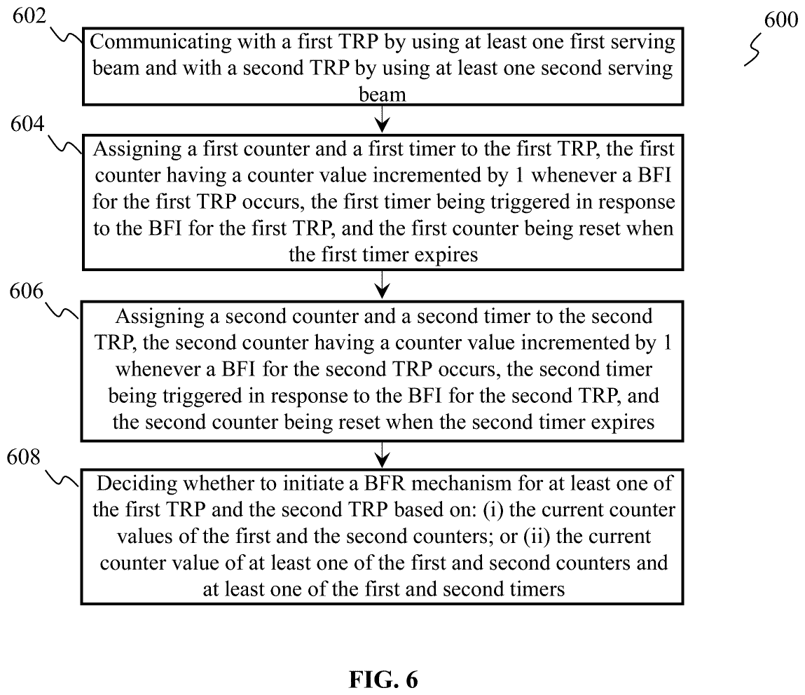

FIG. 6 shows a flowchart of a wireless communication method 600 in accordance with one example embodiment. Each of the steps of the method 600 is intended to be performed by corresponding one of the above-described constructive elements constituting the UE 500. The method 600 starts with a step S602, in which the processor 502 causes the transceiving unit 506 to communicate with a first TRP by using one or more first serving beams and with a second TRP by using one or more second serving beams. The first and second TRPs may be arranged either in the same cell or in different two cells. For example, the first TRP may be arranged in a serving cell, while the second TRP may be arranged in a non-serving cell or a cell configured for inter-cell mTRP or for inter-cell communications. Then, the method 600 proceeds to a step S604, in which the processor 502 assigns a first counter and a first timer to the first TRP. The first counter has a counter value incremented by 1 whenever a BFI for the first TRP occurs. The BFI for the first TRP means that the first serving beam(s) is(are) no longer able to provide a predefined communication quality (e.g., the BFI for the first TRP may imply that all RSs included in the first set of RSs for beam failure detection become unable to provide a predefined communication quality). The first timer is triggered in response to the BFI for the first TRP, and the first counter is reset when the first timer expires. Next, the method 600 goes on to a step S606, in which the processor 502 assigns a second counter and a second timer to the second TRP. Similar to the first counter, the second counter has a counter value incremented by 1 whenever a BFI for the second TRP occurs. The BFI for the second TRP means that the second serving beam(s) is(are) no longer able to provide the predefined communication quality (e.g., the BFI for the second TRP may imply that all RSs included in the second set of RSs for beam failure detection become unable to provide a predefined communication quality). Similar to the first timer, the second timer is triggered in response to the BFI for the second TRP, and the second counter is reset when the second timer expires. The steps S604 and S606 may be performed in parallel, if required and depending on particular applications. It should be noted that the BFI indication may be determined based on a set of DL RSs identifying the serving beams. After that, the method 600 proceeds to a step S608, in which the processor 502 decides whether to initiate a BFR mechanism for at least one of the first TRP and the second TRP based on: (i) the current counter values of the first counter and the second counter; or (ii) the current counter value of at least one of the first counter and the second counter and at least one of the first timer and the second timer (i.e. current timer statuses indicative of whether the first timer and/or the second timer has expired or not). Thus, the current counter values and the current timer statuses define certain selection rules for the processor 502.

For example, the BFR mechanism for both the first and second TRPs (i.e. the cell-level BFR mechanism) may be initiated, for example, as defined in 3GPP Release 15/Release 16 using a BFR MAC CE or Contention Free Beam Failure Recovery Request (RACH) (CFRA)/Contention Based RACH (CBRA) recovery. At the same time, the BFR for one of the first and second TRPs may be initiated, for example, as currently agreed in 3GPP Release 17 where TRP may be recovered individually in a TRP-specific manner.

It should be noted that the method 600 is not limited to the two-TRP scenario and may be equally applied in other mTRP scenarios (i.e. where more than two TRPs are involved) in some other embodiments. The two-TRP scenario is selected herein for the sake of simplicity. Correspondingly, the total number of the counters and the total number of the timers will depend on the total number of the TRPs involved in the method 600.

As used in the embodiments disclosed herein, the indication “BFI for the first (second) TRP occurs” may refer to the failure of RSs in the BFD-RS set associated with the serving beams of the first (second) TRP. In other words, the TRP failure may refer to the failure of the BFD-RS set associated with the CORESETs under specific CPI values (e.g., #0 or #1, as shown in FIG. 4). Given this, each of the first and second counters refers to a counter that is configured to count the BFI indications for the BFD-RS set associated with the respective TRP.

In one example embodiment, at least one of the first and second timers may be a BFD timer supervising the respective counter(s). In some example embodiments, the first and second timers (e.g., BFD timers) may be configured individually for the first and second TRPs, or the first and second timers may be configured as a common timer for the first and second TRPs (e.g., a separate common BFD timer). In one other example embodiment, at least one of the first and second timers may be a timer explicitly configured and assigned a value by a network in which the first and second TRPs are used.

As noted above, the processor 502 may decide, in the step S608, whether to initiate the BFR mechanism for at least one of the first TRP and the second TRP based on the current counter values of the first and the second counters and the timer statuses of the first and second timers. Therefore, the rules used by the processor 502 in the step S608 may be conveniently divided into two groups, with the first group comprising the rules based only on the current counter values and the second group comprising the rules based on the combination of the current counter values and the timer statuses. Each of the two groups is described below in more detail.

### Rules Based Only on Current Counter Values

Given that each of the first counter and the second counter has a maximum counter value, the processor 502 should decide, in the step S608, to initiate the BFR mechanism for both the first TRP and the second TRP (i.e. the cell-level BFR mechanism) when:
the current counter value of the first (second) counter is equal to the maximum counter value of the first (second) counter, and the current counter value of the second (first) counter is equal to the maximum counter value of the second (first) counter or a predefined counter value (the predefined counter value may be provided by one of the TRPs and may be less than or equal to the maximum counter value of the second (first) counter); or
the sum of the current counter values of the first counter and the second counter is equal to: (i) the lowest or highest of the maximum counter values of the first counter and the second counter; or (ii) a sum of the maximum counter values of the first counter and the second counter; or (iii) a predefined threshold value; or
the current counter value of the first (second) counter reaches the maximum counter value of the first (second) counter at a time instant, and the current counter value of the second (first) counter reaches the maximum counter value of the second (first) counter within a predefined time interval from the time instant (the time interval may be configured by one of the TRPs in explicit manner, e.g., in terms of milliseconds or slots).

At the same time, the processor 502 should decide, in the step S608, to initiate the BFR mechanism only for the first (second) TRP when:
the current counter value of the first (second) counter is equal to the maximum counter value of the first (second) counter, and the current counter value of the second (first) counter is equal to 0 (i.e. no BFI indications have been received for the second (first) counter); or
the current counter value of the first (second) counter reaches the maximum counter value of the first (second) counter, while the current counter value of the second (first) counter is less than the maximum counter value of the second (first) counter or the predefined counter value.

It should be noted that the maximum counter values of the first and second counters may be jointly configured (i.e. the first and second counters may have the same maximum counter value) or may be independently configured (i.e. the first and second counters may have different maximum counter values).

### Rules Based on a Combination of Current Counter Values and Timer Statuses

Given that each of the first counter and the second counter has a maximum counter value, the processor 502 should decide, in the step S608, to initiate the BFR mechanism for both the first TRP and the second TRP (i.e. the cell-level BFR mechanism) when:
the current counter value of the first (second) counter is equal to the maximum counter value of the first (second) counter, a new BFI for the second (first) TRP occurs before the second (first) timer expires, and the new BFI makes the current counter value of the second (first) counter equal to the maximum counter value of the second (first) counter; or
the current counter value of the first (second) counter is equal to the maximum counter value of the first (second) counter, a new BFI for the second (first) TRP occurs before the second (first) timer expires, and the new BFI makes the current counter value of the second (first) counter equal to a predefined counter value (again, the predefined counter value may be provided by one of the TRPs and may be less than or equal to the maximum counter value of the second (first) counter); or
the current counter value of the first (second) counter is equal to the maximum counter value of the first (second) counter, and a new BFI for the second (first) TRP occurs before the second (first) timer expires; or
the current counter values of the first and second counters are equal to the maximum counter values of the first and second counters, respectively, and a new BFI for the first (second) TRP occurs before the second (first) timer expires.

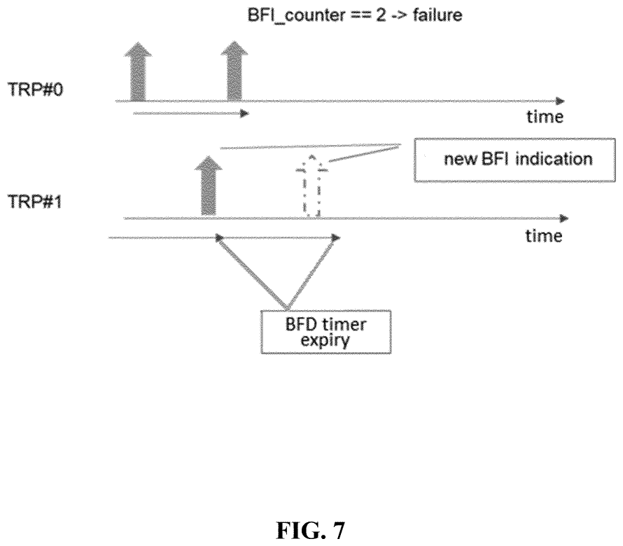

At the same time, the processor 502 should decide, in the step S608, to initiate the BFR mechanism only for the first (second) TRP when:
the current counter value of the first (second) counter is equal to the maximum counter value of the first (second) counter, and the second (first) timer has expired (this rule is schematically illustrated in FIG. 7, in which the first TRP is denoted as TRP #0 and the second TRP is denoted as TRP #1, the maximum counter value for the first counter is equal to 2 and is achieved upon the expiry of the second timer (see “BFD timer expiry” schematically shown as an end of a corresponding arrow)).

It should be again noted that the maximum counter values of the first and second counters may be jointly configured (i.e. the first and second counters may have the same maximum counter value) or may be independently configured (i.e. the first and second counters may have different maximum counter values).

Any of the embodiments disclosed herein is applicable for inter-cell mTRP communications. As an example, the first TRP may be associated with a serving cell (e.g., PCell/SpCell), while the second TRP may be associated with a non-serving cell. Both the serving cell and the non-serving cell may serve the UE in the inter-cell mTRP communications.

Furthermore, each of the predefined counter value and the predefined threshold value used in the above-defined rules may mean a value configured by the network in which the UE 500 communicates with the first and second TRPs. Alternatively, it may mean a value specified in standards (e.g., 3GPP TS 38.331).

Once the concurrent or simultaneous failure of the first and second TRPs (or multiple/all TRPs) of given one or more cells is determined in the step S608 of the method 600, the UE may recover the TRPs using the cell-level BFR mechanism, or the UE may recover the TPRs individually using separate BFR mechanisms, or UE may recover the TRPs individually using a single BFR mechanism. When the UE has determined to trigger the cell-level BFR mechanism, it may provide the failure indication in a MAC CE like the MAC CE 300. The MAC CE may indicate the failure (and recovery) of the serving cell. In case of the separate BFR mechanisms, the UE may provide the failure indication in a MAC CE that includes information on at least the failed TRP (such as candidate beam availability, candidate beam identification (ID) and/or failed TRP ID/BED-RS set ID). In case of the single BFR mechanism, the UE may provide the failure indication in a MAC CE that includes information on both (or all) of the failed TRPs (such as candidate beam availability, a candidate beam ID and/or failed TRP ID/BED-RS set ID). In one example embodiment, when the UE has determined the failure of both the first and second TRPs (concurrently) according to the above-defined rules, the UE may trigger the BFR mechanism to recover the TRPs. The TRP-specific BFR mechanism may involve indicating the TRP failure for at least one of the first and second TRPs and providing TRP-specific candidate beam information (that may comprise an indication of candidate beam availability and a candidate index value, if available) to the network.

In one example embodiment, the processor 502 may additionally check in the step S608 of the method 600 whether at least one of the first and second TRPs is a specific TRP. As used herein, the specific TRP may refer to a TRP that configures the UE 500 to perform monitoring of a certain CORESET (i.e. either for the first or second TRP). If none of the first and second TRPs is configured as the specific TRP and the first (second) counter reaches its maximum counter value, the UE 500 may initiate the BFR mechanism in accordance with any one of the above-described rules (either from the first or second group). However, if the first (second) TRP is configured as the specific TRP and the first (second) counter reaches its maximum counter value, the UE 500 may initiate the BFR mechanism for the failed first (second) TRP without considering the second (first) TRP (in case if the second (first) TRP also fails while the UE 500 has triggered but not yet sent any beam failure recovery request (BFRQ) (e.g., a MAC CE like the MAC CE 300), the UE 500 may switch to the cell-level BFR mechanism).

In one example embodiment, the method 600 may comprise a further step, after the step S608, in which the processor 502 of the UE 500 encodes BFR information into BFRQ (e.g., a BFR MAC CE like the MAC CE 300, or a Truncated BFR MAC CE, or the like). In one example embodiment, the processor 502 may indicate the TRP that failed for a specific serving cell by using candidate beam Reference Signal identification (RS ID). For example, the processor 502 may indicate that the beam failure has been detected on the serving cell or on the TRP and indicates the specific TRP for which the beam failure is detected based on the RS ID. In one example embodiment, if no candidate beam is available, e.g., based on a beam quality threshold (such as a RSRP threshold), the processor 502 may indicate that no candidate beam is available and may indicate the TRP for which no candidate beam is available based on one of the candidate RS IDs configured for the TRP. For example, in such a case, the candidate beam RS ID could be the lowest/highest index of the RS ID configured for a given TRP.

In any of the embodiments disclosed herein, the UE 500 may first determine, in the step S608 of the method 600, whether the second (first) timer for the second (first) TRP is running when the beam failure (i.e. the BFI) is detected for the first (second) TPR. If the second (first) timer (e.g., the BFD timer) is running for the second (first) TRP, the UE 500 may determine whether to recover the first (second) TRP or both the first and second TRPs according to the above-defined rules. If the second (first) timer (e.g., the BFD timer) is not running for the second (first) TRP, the UE 500 may determine to recover the first (second) TRP.

It should be noted that each block or step of the method 600, or any combinations of the blocks or steps, can be implemented by various means, such as hardware, firmware, and/or software. As an example, one or more of the blocks or steps described above can be embodied by processor executable instructions, data structures, program modules, and other suitable data representations. Furthermore, the processor executable instructions which embody the blocks or steps described above can be stored on a corresponding data carrier and executed by at least one processor implementing functions of the UE 500. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1-25. (canceled)

26. A user equipment (UE) comprising:
a transceiving unit;
at least one storage unit configured to store processor-executable instructions; and
at least one processor coupled to the at least one storage unit and configured, when executing the processor-executable instructions, to cause the UE at least to:
perform wireless communications with a first transmission reception point (TRP) by using at least one first serving beam and with a second TRP by using at least one second serving beam;
assign a first counter and a first timer to the first TRP, increment a counter value of the first counter by 1 whenever a beam failure instance (BFI) for the first TRP occurs, the BFI for the first TRP meaning that the at least one first serving beam becomes unable to provide a predefined communication quality, trigger the first timer in response to the BFI for the first TRP, and reset the first counter when the first timer expires;
assign a second counter and a second timer to the second TRP, increment a counter value of the second counter by 1 whenever a BFI for the second TRP occurs, the BFI for the second TRP meaning that the at least one second serving beam becomes unable to provide the predefined communication quality, trigger the second timer in response to the BFI for the second TRP, and reset the second counter when the second timer expires,
wherein the first counter and the second counter each have a maximum counter value;
and wherein the UE is further caused to:
initiate a beam failure recovery (BFR) mechanism for both the first TRP and the second TRP if the current counter value of the first counter is equal to the maximum counter value of the first counter, and if the current counter value of the second counter is equal to a predefined counter value, the predefined counter value being less than or equal to the maximum counter value of the second counter;
initiate the BFR mechanism by triggering a contention-based random access procedure; and
provide a medium access control control element (MAC CE) indicating failure of a serving primary cell and candidate beam indexes and availabilities for both the first TRP and the second TRP.

27. The UE of claim 26, wherein the MAC CE further comprises identities of a first beam failure detection—reference signal (BFD-RS) set of the first TRP and of a second BFD-RS set of the second TRP.

28. The UE of claim 26, wherein the UE is further caused to:
initiate the BFR mechanism for both the first TRP and the second TRP if the current counter value of the first counter reaches the maximum counter value of the first counter at a time instant, and the current counter value of the second counter reaches the maximum counter value of the second counter within a predefined time interval from the time instant.

29. The UE of claim 26, wherein the UE is further caused to:
initiate the BFR mechanism for both the first TRP and the second TRP if
the current counter value of the first counter is equal to the maximum counter value of the first counter,
a new BFI for the second TRP occurs before the second timer expires, and
the new BFI makes the current counter value of the second counter equal to the maximum counter value of the second counter.

30. The UE of claim 26, wherein the UE is further caused to:
initiate the BFR mechanism for both the first TRP and the second TRP if
the current counter value of the first counter is equal to the maximum counter value of the first counter,
a new BFI for the second TRP occurs before the second timer expires, and
the new BFI makes the current counter value of the second counter equal to the predefined counter value.

31. The UE of claim 26, wherein the first TRP and the second TRP are arranged in a single cell.

32. A method for a user equipment, comprising:
communicating with a first transmission reception point (TRP) by using at least one first serving beam and with a second TRP by using at least one second serving beam;
assigning a first counter and a first timer to the first TRP, incrementing a counter value of the first counter by 1 whenever a beam failure instance (BFI) for the first TRP occurs, the BFI for the first TRP meaning that the at least one first serving beam becomes unable to provide a predefined communication quality, triggering the first timer in response to the BFI for the first TRP, and resetting the first counter when the first timer expires;
assigning a second counter and a second timer to the second TRP, incrementing a counter value of the second counter by 1 whenever a BFI for the second TRP occurs, the BFI for the second TRP meaning that the at least one second serving beam becomes unable to provide the predefined communication quality, triggering the second in response to the BFI for the second TRP, and resetting the second counter when the second timer expires,
wherein the first counter and the second counter each have a maximum counter value;
and wherein the method further comprises:
initiating a beam failure recovery (BFR) mechanism for both the first TRP and the second TRP if the current counter value of the first counter is equal to the maximum counter value of the first counter, and if the current counter value of the second counter is equal to a predefined counter value, the predefined counter value being less than or equal to the maximum counter value of the second counter;
initiating the BFR mechanism by triggering a contention-based random access procedure; and
providing a medium access control control element (MAC CE) indicating failure of a serving primary cell and candidate beam indexes and availabilities for both the first TRP and the second TRP.

33. The method of claim 32, wherein the MAC CE further comprises identities of a first beam failure detection—reference signal (BFD-RS) set of the first TRP and of a second BFD-RS set of the second TRP.

34. The method of claim 32, further comprising:
initiating the BFR mechanism for both the first TRP and the second TRP if
the current counter value of the first counter reaches the maximum counter value of the first counter at a time instant, and
the current counter value of the second counter reaches the maximum counter value of the second counter within a predefined time interval from the time instant.

35. The method of claim 32, further comprising:
initiating the BFR procedure for both the first TRP and the second TRP if
the current counter value of the first counter is equal to the maximum counter value of the first counter,
a new BFI for the second TRP occurs before the second timer expires, and
the new BFI makes the current counter value of the second counter equal to the maximum counter value of the second counter.

36. The method of claim 32, further comprising:
initiating the BFR mechanism for both the first TRP and the second TRP if
the current counter value of the first counter is equal to the maximum counter value of the first counter,
a new BFI for the second TRP occurs before the second timer expires, and
the new BFI makes the current counter value of the second counter equal to the predefined counter value.

37. The method of claim 32, wherein the first TRP and the second TRP are arranged in a single cell.

38. A computer program product comprising a non-transitory computer-readable medium that stores a computer code, wherein the computer code is configured, when executed by at least one processor, to cause a user equipment (UE) to:
communicate with a first transmission reception point (TRP) by using at least one first serving beam and with a second TRP by using at least one second serving beam;
assign a first counter and a first timer to the first TRP, increment a counter value of the first counter by 1 whenever a beam failure instance (BFI) for the first TRP occurs, the BFI for the first TRP meaning that the at least one first serving beam becomes unable to provide a predefined communication quality, trigger the first timer in response to the BFI for the first TRP, and reset the first counter when the first timer expires;
assign a second counter and a second timer to the second TRP, increment a counter value of the second counter by 1 whenever a BFI for the second TRP occurs, the BFI for the second TRP meaning that the at least one second serving beam becomes unable to provide the predefined communication quality, trigger the second timer in response to the BFI for the second TRP, and reset the second counter when the second timer expires,
wherein each of the first counter and the second counter has a maximum counter value,
and wherein the UE is further caused to:
initiate a beam failure recovery (BFR) mechanism for both the first TRP and the second TRP if the current counter value of the first counter is equal to the maximum counter value of the first counter, and if the current counter value of the second counter is equal to a predefined counter value, the predefined counter value being less than or equal to the maximum counter value of the second counter;
initiate the BFR mechanism by triggering a contention-based random access procedure; and
provide a medium access control control element (MAC-CE) indicating failure of a serving primary cell and candidate beam indexes and availabilities for both the first TRP and the second TRP.

39. The computer program product of claim 38, wherein the MAC CE further comprises identities of a first beam failure detection—reference signal (BFD-RS) set of the first TRP and of a second BFD-RS set of the second TRP.

40. The computer program product of claim 38, wherein the UE is further caused to:
initiate the BFR mechanism for both the first TRP and the second TRP if
the current counter value of the first counter reaches the maximum counter value of the first counter at a time instant,
and the current counter value of the second counter reaches the maximum counter value of the second counter within a predefined time interval from the time instant.

41. The computer program product of claim 38, wherein the UE is further caused to:
initiate the BFR procedure for both the first TRP and the second TRP if
the current counter value of the first counter is equal to the maximum counter value of the first counter,
a new BFI for the second TRP occurs before the second timer expires, and
the new BFI makes the current counter value of the second counter equal to the maximum counter value of the second counter.

42. The computer program product of claim 38, wherein the UE is further caused to:
initiate the BFR procedure for both the first TRP and the second TRP if
the current counter value of the first counter is equal to the maximum counter value of the first counter,
a new BFI for the second TRP occurs before the second timer expires, and
the new BFI makes the current counter value of the second counter equal to the predefined counter value.

43. The computer program product of claim 38, wherein the first TRP and the second TRP are arranged in a single cell.
